(19) United States
(12) Patent Application Publication
(10) Pub. No.: US 2007/0082090 A1
(43) Pub. Date: Apr. 12, 2007

(54) Cooked food preparation

(76) Inventor: Paul Brian Kiser, Cincinnati, OH (US)

Correspondence Address: CURATOLO SIDOTI CO., LPA, 24500 CENTER RIDGE ROAD, SUITE 280, CLEVELAND, OH, 44145, US

(21) Appl. No.: 10/574,866

(22) PCT Filed: Oct. 13, 2004
(86) PCT No.: PCT/CH04/00622

§ 371 Date: Oct. 18, 2006

Related U.S. Application Data
(60) Provisional application No. 60/511,539, filed on Oct. 15, 2003.

(51) Int. Cl. A21D 13/00

(52) U.S. Cl. 426/94

(57) ABSTRACT

A method of glazing food post-cooking comprises the agitation of a hot, freshly-cooked foodstuff in a sealed container containing a seasoning mixture comprising seasonings and a granular, edible substance that, at the temperature of the cooked foodstuff, will form a continuous coating on the foodstuff, which coating is no longer fluid at the temperature at which the foodstuff will be consumed. The method allows considerable versatility in the glazing of foodstuffs.

This invention relates to a method of preparing foodstuffs, and more particularly to a method of seasoning and glazing hot foodstuffs.

Glazing, the technique for coating a foodstuff, particularly meat, but also vegetables and other foodstuffs, to be cooked in an oven, with a clear coating is well known. Glazes contribute lubricity and flavor. A typical glaze consists of fillers such as maltodextrin, spices and flavors for taste, and starches, gums or methyl cellulose for functionality. A glaze is typically hydrated at a ratio of one part dry to two parts water and it is applied to the foodstuff prior to its being heated in an oven. There are problems with this approach. For example, most of the flavors are flashed off during the cooking process. In addition, a glaze may become very tacky and cause problems with the oven belt (the continuous belt carrying foodstuffs through an industrial oven) as well. Glazes often burn when put through an oven, or stick to the belt. In addition, when a flavor has to be changed in an industrial installation, a complete shut-down and clean-up is required.

It has now been found that a foodstuff can be glazed and seasoned by a simple method that overcomes the disadvantages of known practice. The invention therefore provides a method of preparing a foodstuff, comprising the steps of
(a) cooking or heating the foodstuff; and
(b) applying to the cooked foodstuff a seasoning mixture the seasoning mixture comprising seasonings and a granular edible substance that will form on the surface of the foodstuff, at the temperature of the cooked foodstuff, an essentially continuous coating, which coating is no longer fluid at the temperature at which the foodstuff will be consumed.

The seasoning mixture is a mixture of seasonings and an edible substance that forms a coating. By “seasonings” is meant any known ingredient used to confer flavor or color on foodstuffs and including, for example, spices, herbs, flavors and colorings. All of the known flavorings may be used in art-recognized proportions. The mixture may also contain any of the standard ingredients normally found in foodstuffs, such as salt, sugar and oil.

The granular edible substance that forms the continuous coating may be selected from any such substance that will form such a coating in a relatively short time at the temperature of the cooked or heated foodstuff and that will be no longer fluid at the temperature at which the foodstuff will be consumed. By “no longer fluid” is meant that the seasoning mixture has ceased to flow and remains in place on the surface of the foodstuff. The nature of the coating will depend on the nature of the foodstuff and of the seasoning mixture. For example, some coatings may be hard and crystalline, others will be semi-solid or slightly rubbery. The precise nature is not narrowly critical; what is important is that, when the food is consumed, any flow of coating has ceased.

The mechanism by which such a coating is formed depends on the nature of the substance, but the skilled person, given the need for a coating to be formed in these conditions, will be able to formulate a suitable coating for any given foodstuff. For example, the granular edible substance may melt at the temperature of the cooking and flow as a liquid over the surface, before ceasing to flow. Another example is a substance that does not melt at these temperatures, but that combines with water evaporating from the foodstuff (and such evaporation happens to nearly all foodstuffs) to form a coating liquid that flows over the surface of the foodstuff. When the water evaporates, the edible substance is left as a coating on the surface. Other mechanisms of providing such a coating may also be used.

It is not necessary that the entire surface of the foodstuff be coated, although this is the preferred situation. Coverage should preferably be at least 50% of the surface area of the foodstuff (although lower proportions are not excluded). The quantity of seasoning mixture according to this invention should therefore be such that such a coverage is achieved.

By “relatively short time” is meant any convenient time for food preparation. Such a time should not be too long, as this would mean that the food may be too cool, but a suitable time is easily selected for any given foodstuff. A typical acceptable time is of the order of 3-5 minutes, but longer or shorter times are still within the scope of this invention. Foodstuffs are cooked and consumed at a wide range of temperatures, and so the edible substance may be selected to suit any particular foodstuff and temperature range. This is well within the skill of the art.

Examples of suitable edible substances for use in this invention include sugars, ranging from mono- and disaccharides to polyols, such as mannitol, hydrolyzed plant or plant protein, maltodextrins, such as corn syrup, hydrocolloids, such as gums, proteins, food acids, fats and lipids. Not all of these are suitable for all applications, but again the skill of the art is capable of selecting the appropriate substance for any given application.

The finer are the granules, the quicker the coating formation and the more efficient the coating of the foodstuff will be. Preferably the substance should be as fine as possible, typically having granules of the same order of size as bakers' sugar and flour salt. A typical size is one in which 98% will go through a 20 mesh screen (U.S.A. Standard Testing Sieve ASTM E-11 Specification, opening 850 micrometer (0.0331 in.), Tyler equivalent 20 mesh). Examples of materials useful as edible substances in this invention are baker's sugar and anhydrous and hydrous dextrose. Hydrous dextrose has been found to work best of all and is the preferred substance for the purposes of this invention. Hydrous dextrose contains typically about 9% moisture, in contrast to the anhydrous dextrose and other sugars, which typically contain less than 1%. A typical commercial hydrous dextrose suitable for use in this invention is Dextrose 49552 (ex Corn Products).

Although such granular edible substances are already known to be useful in foodstuffs, the present invention requires them to be present in unusually high proportions. The precise proportion will vary with the nature of the seasoning mixture; a typical proportion is of the order of 45-65% by weight of the seasoning mixture, but in some circumstances it is possible to use proportions outside this range.

The application of the seasoning mixture to the freshly cooked or heated foodstuff may be by any convenient means, such as sprinkling or by placing the foodstuff in the seasoning mixture and agitating, such that there is the necessary surface coverage. In a preferred embodiment of the invention, the hot, cooked foodstuff is placed in a sealable container along with the seasoning mixture, and the container sealed and then shaken. The container may be any suitable kind of container, of any material suitable for containing a hot, cooked foodstuff, for example, metal, plastics and ceramics. In one embodiment, it may be a rigid cylindrical container with a lid held in place by a screw thread, clamps or any other suitable closing means. When the foodstuff is in the container with the seasoning mixture, it may be agitated in any suitable way by any suitable means. For example, it may be placed on motorized rollers and rotated, as in a ball mill, or it may be shaken on a shaker of the type used, for example, in the paint industry.

In another embodiment, the container may be a bag or sack of, for example, metal foil or plastics, sealable by any convenient means, such as a clamp or by a closure such as a ZipLock™ closure. Such a container may be more suitable than as rigid container in many circumstances, for example, for domestic use. It has the advantage of being easily stored, and it can be discarded after use, with no need for cleaning. The containers may be of any suitable flexible, bag-forming material, but they are preferably of aluminum foil, of the type normally used in kitchens. During agitation (generally performed by hand), these will become hot, but they can be handled without problems by someone wearing ordinary oven gloves.

In an especially preferred aspect of the invention, containers in the form of bags may be supplied with the seasoning mixture, either in a separate container, or, even more preferably already within the container. In an especially preferred embodiment, the seasoning mixture is deposited on the inner walls of the container. Thus, all that need be done is the addition of the hot, cooked foodstuff to the container, followed by sealing and agitation. After a few minutes, the foodstuff is ready for serving.

Thus, in a further aspect of the invention, there is provided a flexible, sealable container suitable for the containing of a hot, cooked foodstuff, having at least one inner surface, the inner surface being coated with a seasoning mixture comprising seasonings and a granular edible substance, which granular edible substance forms, at the temperature of the cooked foodstuff, a continuous coating on the foodstuff, which coating is no longer fluid at the temperature of consumption of the foodstuff.

Such containers may be supplied as multiples in boxes ready for use, in the manner of freezer bags and the like. Moreover, it is possible to supply containers comprising different types of seasoning mixture, so that a variety of different flavors may be obtained.

The advantages of this method are that it allows less flavor usage because flavor tends to flash off during a conventional oven cooking process. It also enables a processor of foods to mass-produce one item that can be customized at a consumer level, rather than produce different lines, with the accompanying expense and complexity.

The invention is now further described with reference to the following non-limiting example, which describes a preferred embodiment.

### EXAMPLE

The following mixture is made (figures are percentages by weight):

| | |
|---|---|
| fine salt | 2.24 |
| fine sugar | 1.00 |
| oleo resins | 0.02 |
| seasoning | 31.34 |
| Dextrose 49552 | 65.40 |

This mixture is coated on to the interior of a sealable bag of aluminum foil. To the bag is added 200 g of hot, cooked boneless chicken wings. The bag is sealed, shaken, and then shaken approximately every 30 sec. for 5 minutes. The chicken wings were then ready to serve. They were substantially uniformly glazed and seasoned.

1. A method of preparing a foodstuff, the method comprising:
a. Cooking or heating the foodstuff; and
b. Applying to the cooked foodstuff a seasoning mixture; the seasoning mixture comprising seasonings and a granular edible substance that will form on the surface of the foodstuff, at the temperature of the cooked foodstuff, an essentially continuous coating, which coating is no longer fluid at the temperature at which the foodstuff will be consumed.

2. A method according to claim 1, in which the granular edible substance comprises at least one of baker's sugar, anhydrous dextrose or hydrous dextrose.

3. A method according to claim 1, in which the granular edible substance is hydrous dextrose.

4. A sealable container for the containing of a hot, cooked foodstuff, having at least one inner surface, the inner surface being coated with a seasoning mixture comprising seasonings and a granular edible substance, which granular, edible substance forms, at the temperature of the cooked foodstuff, a continuous coating on the foodstuff, which coating is no longer fluid at the temperature of consumption of the foodstuff.

5. A container according to claim 4, in which the sealable container is flexible.

6. A container according to claim 5, in which the container is a bag or sack made of metal or plastics.
